(19) United States
(12) Patent Application Publication
(10) Pub. No.: US 2026/0161639 A1
(43) Pub. Date: Jun. 11, 2026

(54) REDUCING LATENCY, IN GENERATING OUTPUT RESPONSE TO A USER QUERY, BASED ON PROCESSING THE USER QUERY USING GENERATIVE MODEL(S)

(71) Applicant: GOOGLE LLC, Mountain View, CA (US)

(72) Inventors: Brett Barros, San Mateo, CA (US); Kimberly Harvey, Los Angeles, CA (US)

(21) Appl. No.: 18/972,267

(22) Filed: Dec. 6, 2024

(51) Int. Cl. G06F 16/242

(52) U.S. Cl. CPC G06F 16/2425; G06F 16/243; G06F 16/2448

(57) ABSTRACT

Reducing latency during a dialog session between a user and a client device. Implementations can reduce the time between (1) when the user finishes providing the user query and (2) when the system begins to respond to the user query. In some implementations, instead of generating a single prompt for processing using a generative model, multiple prompts are generated for processing using one or more generative models, and output generated from processing of the first prompt is rendered prior to completion of processing of the second prompt.

### BACKGROUND

Various generative models have been proposed that can be used to process natural language (NL) content and/or other input(s), to generate output that reflects generative content that is responsive to the input(s). For example, large language models (LLM(s)) have been developed that can be used to process NL content and/or other input(s), to generate LLM output that reflects generative NL content and/or other generative content that is responsive to the input(s). For instance, an LLM can be used to process NL content of “how to change DNS settings on Acme router”, to generate LLM output that reflects several responsive NL sentences such as: “First, type the router's IP address in a browser, the default IP address is 192.168.1.1. Then enter username and password, the defaults are admin and admin. Finally, select the advanced settings tab and find the DNS settings section”. However, current utilizations of generative models suffer from one or more drawbacks.

As one example, many generative models can be of a very large size, often including billions of parameters (e.g., over 100 billion parameters, over 250 billion parameters, or over 500 billion parameters). Due to the large size of such a generative model, significant memory, processor, power, and/or other computational resource(s) can be required to process an input, using the generative model, to generate a corresponding generative output. This resource utilization can be significant on a per input basis, and very significant when hundreds or thousands of inputs are being processed per minute, per second, or other interval. Also, due to the large size of such a generative model, there can be significant latency in generating a corresponding generative output and, as a result, in rendering corresponding generative content. Such latency can lead to prolonging of a user-to-computer interaction. Further, due to the large size of such a generative model, many or all client devices may be unable to utilize such a generative model on-device. For example, memory constraints of a client device can prevent such a generative model from being loaded into memory.

### SUMMARY

Implementations described herein are directed towards reducing latency during a dialog session between a user and a client device, where at least part of the output responsive to a user query is generated using a generative model. In some implementations, the system can reduce the time between (1) when the user finishes providing the user query, and (2) when the system begins to respond to the user query. In some versions of those implementations, instead of generating a single prompt for processing using the generative model, the system can generate multiple prompts for processing using one or more generative models.

A user query which identifies an action to call to an Application Programming Interface (API) causes latency in the system. For example, a user can provide a user query of “How much are flights from Boston to San Francisco”. In generating a response to the user query of “How much are flights from Boston to San Francisco”, the system can generate a prompt that includes the user query of “How much are flights from Boston to San Francisco” along with an API call for “Flights API”. The API call for “Flights API” increases the latency of generating a response to the user query (compared with generating a response to a user query that does not require an API call), as the time to generate the response to the user query is dependent on the time to generate the API call.

In some implementations, instead of generating and processing a single prompt, the system can generate at least two prompts for processing using one or more generative models. For instance, the system can generate an initial prompt which includes at least the user query of “How much are flights from Boston to San Francisco” without the API call, and an additional prompt which includes at least the user query of “How much are flights from Boston to San Francisco” and the API call for “Flights API”. The system can process the initial prompt using a generative model to generate a first portion of a response, where the first portion of the response can be rendered for the user while the additional prompt is being processed using the generative model or an additional generative model to generate a second portion of the response. The second portion of the response can be rendered for the user temporally after rendering of the first portion of the response. In other words, processing the user query of “How much are flights from Boston to San Francisco” using a single prompt that includes the user query of “How much are flights from Boston to San Francisco” and the API call for “Flights API” takes a first value of time to render the response to the user query. In contrast, by processing the user query of “How much are flights from Boston to San Francisco” using two prompts, the system can begin rendering responsive output to the user after the first portion of the response has been generated, where rendering the first portion of the response takes a second value of time, where the first value of time is larger than the second value of time.

Additionally or alternatively, a user query can identify a large context window from which to generate a response. For example, a user can provide a user query of “What is a summary of ‘Hypothetical Science Paper’”, where the ‘Hypothetical Science Paper’ includes 8 chapters and millions of tokens. In generating a response to the user query of “What is a summary of ‘Hypothetical Science Paper’”, the system can generate a prompt that includes the user query of “What is a summary of ‘Hypothetical Science Paper’” along with the 8 chapters of the paper. Processing the 8 chapters of the paper increases the latency of generating a response to the user query (compared with generating a response to a user query that does not include the 8 chapters of the paper), as the time to generate the response to the user query is dependent on the time to process the 8 chapters of the paper.

In some implementations, instead of generating and processing a single prompt, the system can generate at least two prompts for processing using one or more generative models. For instance, the system can generate an initial prompt which includes at least the user query of “What is a summary of ‘Hypothetical Science Paper’” with the first chapter of the paper as context, and an additional prompt which includes at least the user query of “What is a summary of ‘Hypothetical Science Paper’” and the entire 8 chapters of the paper. The system can process the initial prompt using a generative model to generate a first portion of a response, where the first portion of the response can be rendered for the user while the additional prompt is being processed using the generative model or an additional generative model to generate a second portion of the response. The second portion of the response can be rendered for the user temporally after rendering of the first portion of the response. In other words, processing the user query of “What is a summary of ‘Hypothetical Science Paper’” using a single prompt that includes the user query of “What is a summary of ‘Hypothetical Science Paper’” and the 8 chapters of the paper takes a first value of time to render the response to the user query. In contrast, by processing the user query of “What is a summary of ‘Hypothetical Science Paper’” using two prompts, the system can begin rendering responsive output to the user after the first portion of the response has been generated, where rendering the first portion of the response takes a second value of time, where the first value of time is larger than the second value of time.

In some implementations, the initial prompt can include only the user query (and no additional information). For example, the initial prompt can include the user query of “How much are flights from Boston to San Francisco” without the API call for “Flights API” and without any additional context. In some other implementations, the initial prompt can include the user query and some additional information but not the entire context. For instance, the initial prompt can include the user query of “Summary of ‘Hypothetical Science Paper’” with only the first chapter of the paper. In some further implementations, the initial prompt can include the user query and cached information. For instance, the initial prompt can include the user query of “How much are flights from Boston to San Francisco” with the context of historical flight prices (but without the API call for “Flights API”).

In some implementations, the system can process the user query using a latency engine to generate a predicted latency associated with generating a response to the user query. When the predicted latency satisfies a threshold value, the system can generate the initial prompt and the additional prompt (rather than generating a single prompt). In some implementations, the latency engine can use historical time values to call a given API, the historical time values of generating a prompt using a given generative model, the size of the context, one or more additional or alternative predicted latency values, and/or combinations thereof.

The above description is provided as an overview of only some implementations disclosed herein. These and other implementations are described in more detail herein, including in the detailed description and the claims.

It should be appreciated that all combinations of the foregoing concepts and additional concepts described in greater detail herein are contemplated as being part of the subject matter disclosed herein. For example, all combinations of claimed subject matter appearing at the end of this disclosure are contemplated as being part of the subject matter disclosed herein.

### BRIEF DESCRIPTION OF THE DRAWINGS

FIG. 1A illustrates an example timing diagram for generating a response to a user query using a generative model in accordance with various implementations.

FIG. 1B illustrates another example timing diagram for generating a response to a user query using a generative model in accordance with various implementations.

FIG. 2 illustrates a flowchart depicting an example process in accordance with various implementations.

FIG. 3 illustrates an example environment in which various implementations disclosed herein may be implemented.

FIG. 4 illustrates an example architecture of a computing device.

### DETAILED DESCRIPTION

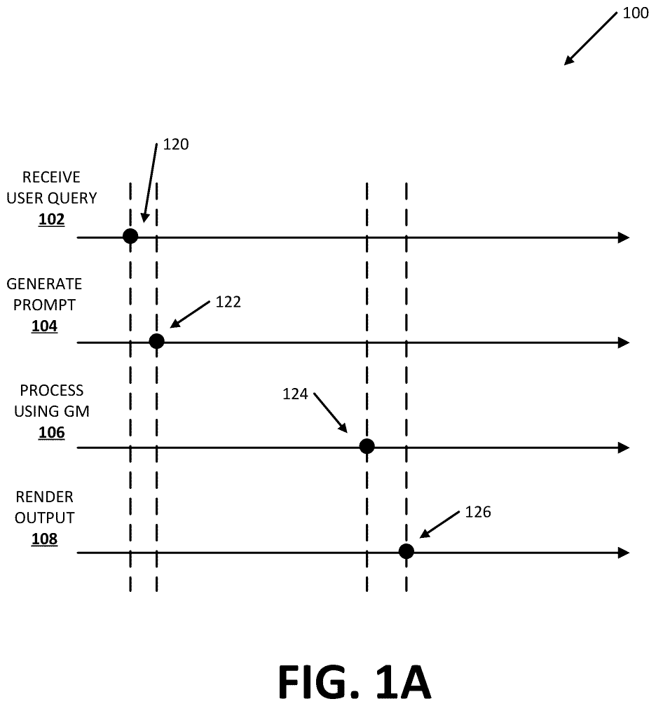

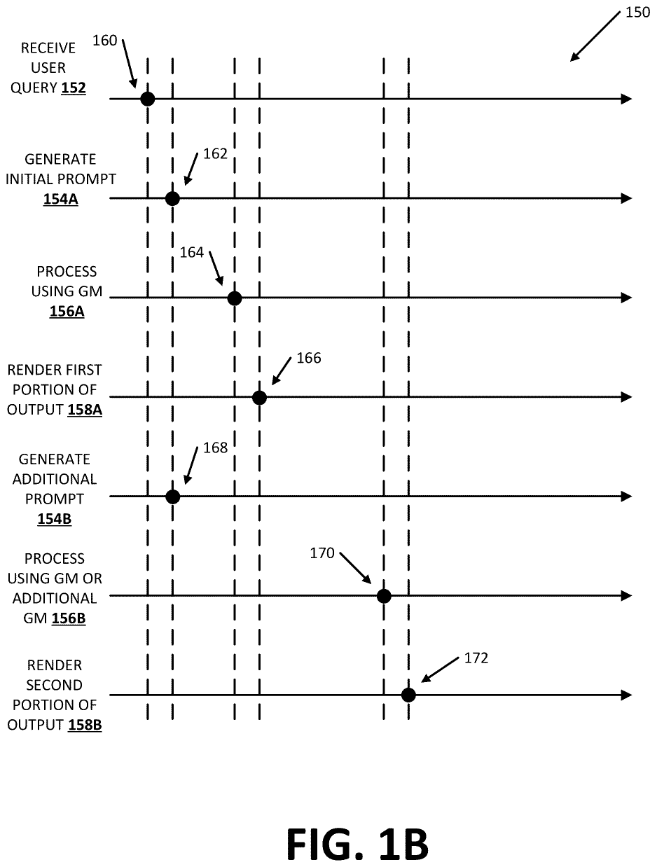

Turning now to the figures, FIG. 1A and FIG. 1B illustrate example timing diagrams of generating a response to a user query using a generative model in accordance with various implementations. FIG. 1A illustrates timing diagram 100 of generating a response to a user query using a generative model based on a single prompt (e.g., the system generates a prompt based on the user query and the system processes the prompt using a generative model to generate output responsive to the user query). FIG. 1A includes a time representation 102 of receiving a user query, a time representation 104 of generating a prompt based on the user query, a time representation 106 of processing the prompt using the generative model, and a time representation 108 of generating a response to the user query based on the output of the generative model.

At point 120, the system receives a user query, which is generated based on user interface input provided at a client device. In some implementations, the system can begin to receive the user interface input prior to point 120 (not depicted) and can receive the complete user interface input at point 120. At point 122, the system processes the user query to generate a prompt corresponding to the user query. In the illustrated example 100, the system generates a single prompt based on the user query. For example, when a user provides the user query of “How much are flights from Boston to San Francisco,” the system can generate a prompt that includes at least the user query of “How much are flights from Boston to San Francisco?” and a call to “Flights API”. The system can begin processing the prompt after it is generated (not depicted) and can complete processing of the prompt using the generative model at point 124. Additionally or alternatively, the system can render output, responsive to the user query at point 126. The latency of generating the responsive output in example 100 is the time between point 120 and point 126.

Similarly, FIG. 1B illustrates example timing diagram 150, where the system generates a response to the user query based on two prompts (e.g., the system generates an initial prompt and an additional prompt based on the user query instead of generating a single prompt based on the user query). FIG. 1B includes a time representation 152 of receiving a user query, a time representation 154A of generating an initial prompt based on the user query, a time representation 156A of processing the initial prompt using a generative model to generate the first portion of the response, a time representation 158A of rendering the first portion of the response to the user, a time representation 154B of generating an additional prompt based on at least the user query, a time representation 156B of processing the additional prompt using the generative model or an additional generative model to generate a second portion of the response, and a time representation 158B of rendering the second portion of the response to the user.

At point 160, the system receives a user query, which is generated based on user interface input provided at a client device. In some implementations, the system can begin to receive the user interface input prior to point 160 (not depicted) and can receive the complete user interface input at point 160. At point 162, the system processes the user query to generate an initial prompt corresponding to the user query. For example, the user can provide the user query of “How much are flights from Boston to San Francisco?” and the system can generate an initial prompt that includes at least the user query of “How much are flights from Boston to San Francisco?”. At point 164, the system processes the initial prompt using a generative model to generate the first portion of the response. At point 166, the system renders the first portion of the response to the user.

At point 168, the system generates an additional prompt based on at least the user query. In some implementations, the system can generate the initial prompt (point 162) at the same time it generates the additional prompt (point 168). In some other implementations, the system can generate the additional prompt (point 168) after generating the initial prompt (point 162) but prior to the initial prompt being processed using the generative model (point 164). In some further implementations, the system can generate the additional prompt (point 168) after the system processes the initial prompt using the generative model (point 164). In some versions of those implementations, the first portion of the output can be included as part of the additional prompt.

In some implementations, the system finishes processing the additional prompt using the generative model or an additional generative model (point 170) to generate the second portion of the response. At point 172, the system renders the second portion of the response to the user. In some implementations, the second portion of the response is rendered temporally after the first portion of the response.

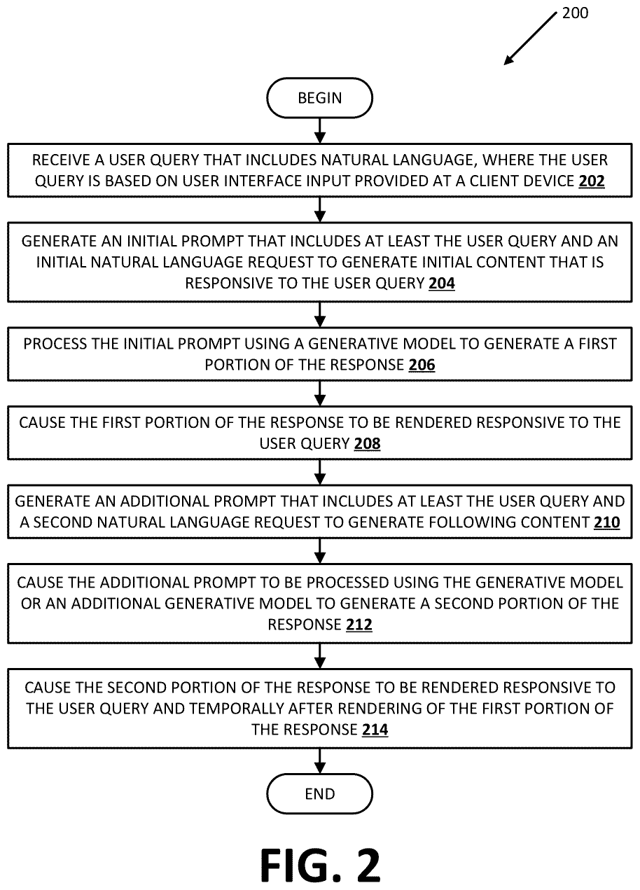

FIG. 2 is a flowchart illustrating an example process 200 in accordance with various implementations described herein. For convenience, the operations of the flowchart are described with reference to a system that performs the operations. This system may include various components of various computer systems, such as one or more components of client device 302 and/or computing system 410. Moreover, while operations of process 200 are shown in a particular order, this is not meant to be limiting. One or more operations may be reordered, omitted, and/or added.

At block 202, the system receives a user query that includes natural language, where the user query is generated based on user interface input provided at a client device. For example, the system can receive natural language text input from a user via user interface input device 304. Additionally or alternatively, the system can receive audio data that captures an utterance spoken by a user and can optionally perform automatic speech recognition (ASR) and/or natural language understanding (NLU) to generate the user query from the audio data. For example, the system can receive the user query of “how much are flights from Boston to San Francisco.”

At block 204, the system generates an initial prompt based on the user query, where the initial prompt includes at least the user query and an initial natural language request to generate initial content that is responsive to the user query. For example, the system can generate an initial prompt which only includes the user query of “how much are flights from Boston to San Francisco.” Additionally or alternatively, the system can generate an initial prompt that includes the user query of “How much are flights from Boston to San Francisco?” and historical flight data (e.g., prices, times, etc.).

At block 206, the system processes the initial prompt using a generative model to generate a first portion of a response to the user query.

At block 208, the system renders the first portion of the response to the user.

At block 210, the system generates an additional prompt based on at least the user query. In some implementations, the additional prompt can include one or more actions that cause latency in rendering the response to the user (e.g., calling an API, processing a large corpus of content, etc.). For example, the additional prompt for “How much are flights from Boston to San Francisco?” can include the user query and a call to the “Flights API.”

At block 212, the system causes the additional prompt to be processed using the generative model or an additional generative model to generate a second portion of the response. In some implementations, the additional prompt can be processed using a generative model stored locally at the client device. In some other implementations, the additional prompt can be processed using a generative model remote from the client device (e.g., when the generative model is stored at a server remote from the client device).

At block 214, the system causes the second portion of the response to be rendered to the user. In some implementations, the second portion of the response can be rendered prior to completing the rendering of the first portion of the response.

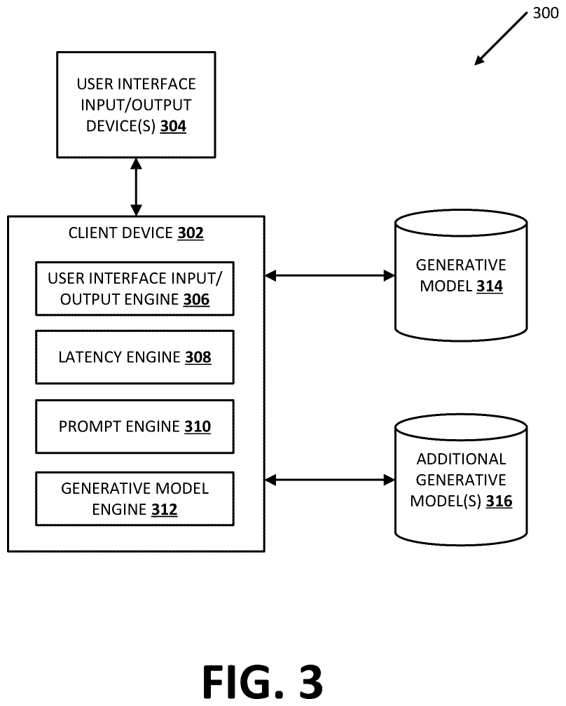

FIG. 3 is a block diagram of an example environment 300 that demonstrates various aspects of the present disclosure, and in which implementations disclosed herein can be depicted. The example environment 300 includes a computing device 302, user interface input/output device(s) 304, one or more additional or alternative components (not depicted), and/or combinations thereof. The computing device 302 includes user interface input/output engine 306, latency engine 308, prompt engine 310, generative model engine 312, generative model 314, one or more additional generative model(s) 316, one or more additional engines (not depicted), one or more additional components (not depicted), and/or combinations thereof.

In some implementations, computing device 302 and/or additional or alternative components may be communicatively coupled with each other via one or more networks, such as one or more wired or wireless local area networks (“LANs,” including Wi-Fi LANs, mesh networks, Bluetooth, near-field communication, etc.) or wide area networks (“WANs”, including the Internet).

In some implementations, the computing device 302 may include one or more user interface input/output devices 304, which may include, for example, a physical keyboard, a touch screen (e.g., implementing a virtual keyboard or other textual input mechanisms), a microphone, a camera, a display screen, and/or speaker(s). The user interface input/output device(s) may be incorporated with one or more client devices 302 of a user. For example, a mobile phone of the user may include the user interface input output devices; a standalone digital assistant hardware device may include the user interface input/output device; a first computing device may include the user interface input device(s) and a separate computing device may include the user interface output device(s); etc. In some implementations, all or aspects of client device 302 may be implemented on a computing system that also contains the user interface input/output devices.

Some non-limiting examples of client device 302 include one or more of: a desktop computing device, a laptop computing device, a standalone hardware device at least in part dedicated to an automated assistant, a tablet computing device, a mobile phone computing device, a computing device of a vehicle (e.g., an in-vehicle communications system, and in-vehicle entertainment system, an in-vehicle navigation system, an in-vehicle navigation system), or a wearable apparatus of the user that includes a computing device (e.g., a watch of the user having a computing device, glasses of the user having a computing device, a virtual or augmented reality computing device). Additional and/or alternative computing systems may be provided. Client device 302 may include one or more memories for storage of data and software applications, one or more processors for accessing data and executing applications, and other components that facilitate communication over a network. The operations performed by client device 302 may be distributed across multiple computing devices. For example, computing programs running on one or more computers in one or more locations can be coupled to each other through a network.

In some implementations, user interface input/output engine 306 can process user interface input received via one or more of the user interface input device(s) 304 to generate the user query. For example, the user can provide natural user interface input by speaking, or providing touch input, gesture input, touch gestures, typed input, typed touch gestures, physical button presses, key press combinations, and/or other natural language or non-natural language user interface input. Additionally or alternatively, user interface input/output engine 306 can render the first portion of the response and/or the second portion of the response (e.g., the first portion of the response or the second portion of the response generated using generative model engine 312). In some implementations, the user interface input/output engine 306 can process the first portion of response and the second portion of response using a generative model (e.g., generative model 314, one or more additional generative models 316, etc.) to generate a revised second portion of the response. The revised second portion of response can include one or more additional or alternative words (compared to the second portion of the response) to link the first portion of the response to the second portion of the response.

In some implementations, latency engine 308 can process the user query to determine whether to generate an initial prompt and an additional prompt based on the user query. For example, latency engine 308 can determine whether the user query includes one or more actions that cause latency in rendering the response to the user (e.g., calling an API, processing a large corpus of content, etc.). In some implementations, the latency engine 308 can determine whether the user query includes one or more actions that cause latency in rending the response based on historical latency of API calls, historical latency of generative models, a size of a corresponding corpus of content, etc.

In some implementations, when latency engine 308 determines to generate an initial prompt and an additional prompt based on processing the user query, prompt engine 310 can generate the initial prompt and the additional prompt. For example, the prompt engine 310 can generate an initial prompt that includes at least the user query and an initial natural language request to generate initial content that is responsive to the user query. In some implementations, the initial natural language request can include a request to rephrase a portion of the user query. For example, for the user query of “How much are flights from Boston to San Francisco,” the prompt engine 310 can generate an initial prompt that includes the user query of “How much are flights from Boston to San Francisco?” and a request to rephrase the user query. Additionally or alternatively, the prompt engine 310 can generate an additional prompt that includes at least the user query and a second natural language request to generate following content that is responsive to the user query. For example, the prompt engine 310 can generate an additional prompt that includes the user query of “How much are flights from Boston to San Francisco?” and a call to the “Flights API”.

Additionally or alternatively, the system can receive a user query of “what is a summary of ‘Hypothetical Science Paper’”, where ‘Hypothetical Science Paper’ includes eight chapters and millions of tokens. The prompt engine 310 can generate an initial prompt that includes at least “What is a summary of ‘Hypothetical Science Paper’?” and the first chapter of ‘Hypothetical Science Paper’ as context. Similarly, the prompt engine 310 can generate an additional prompt that includes at least “What is a summary of ‘Hypothetical Science Paper’?” and all eight chapters of ‘Hypothetical Science Paper’ as context.

In some implementations, the initial natural language request of the initial prompt can include an instruction of how to begin the first portion of the response. For example, the initial natural language request of the initial prompt can include an instruction to begin the first portion of the response with “As an overview, ‘Hypothetical Science Paper’ discusses”. In some implementations, the initial natural language request of the initial prompt can include instructions of how to end the first portion of the response. For example, the initial natural language request of the initial prompt can include an instruction to end the first portion of the response with “‘In more detail, ‘Hypothetical Science Paper’ describes”. Similarly, the additional natural language request of the additional prompt can include an instruction of how to begin the second portion of the response (e.g., based on the instruction of how to end the initial response). For example, when the initial natural language request includes an instruction to end the first portion of the prompt with “In more detail, ‘Hypothetical Science Paper’ describes”, the second natural language request of the additional prompt can include an instruction to begin the second portion of the response with “In more detail, ‘Hypothetical Science Paper’describes”.

In some implementations, generative model engine 312 can process the initial prompt (e.g., the initial prompt generated using prompt engine 310) using a generative model 314 to generate a first portion of a response to the user query. Similarly, generative model engine 312 can process the additional prompt (e.g., the additional prompt generated using prompt engine 310) the generative model 314 or one or more additional generative models 316 to generate a second portion of the response to the user query. In some implementations, the generative model 314 is stored locally at the client device (e.g., client device 302). In some other implementations, the generative model 314 is stored remotely from the client device (e.g., at a server remote from the client device). Similarly, in some implementations, the one or more additional generative models 316 are stored locally at the client device (e.g., client device 302). In some other implementations, the one or more additional generative models 316 are stored remotely from the client device (e.g., at a server remote from the client device).

In some implementations, the generative model 314 and/or the one or more additional generative models 316 described herein can be any sequence-to-sequence based machine learning model capable of generating generative vision data, generative audio data, generative textual data, and/or other forms of generative data. Some non-limiting examples of these sequence-to-sequence based machine learning models that are capable of generating one or more forms of the generative data noted above include transformer-based machine learning models (e.g., encoder-decoder transformer models, encoder-only transformer models, decoder-only transformer models, double encoder-only transformer models, etc.), stable diffusion-based machine learning models, recurrent neural network-based machine learning modes, generative adversarial network-based machine learning models, etc.

Various sequence-to-sequence based machine learning models have demonstrated multimodal capabilities in that they are capable of processing inputs in various modalities (e.g., text-based inputs, vision-based inputs, audio-based inputs, etc.) and generating outputs in various modalities (e.g., text-based output, vision-based outputs, audio-based generative outputs, etc.). Some particular non-limiting examples of these sequence-to-sequence based machine learning models that have demonstrated multimodal capabilities include the Gemini family of models, the ChatGPT family of models, the Claude family of models, the Llama family of models, and/or other families of sequence-to-sequence generative models. However, it should be noted that the generative models described herein are an example of generative machine learning models and are not intended to be limiting.

Additionally or alternatively, the generative model can include millions or billions of weights and/or parameters that are learned through training and/or fine-tuning the generative model on enormous amounts of diverse data. This enables the generative model to generate output based on a probability distribution over the sequence of tokens.

Although FIG. 3 is described with respect to a single client device having a single user, it should be understood that is for the sake of example and is not meant to be limiting. For example, one or more additional client devices of a user can also implement the techniques described herein. For instance, the computing device 402, the one or more additional client devices, and/or any other computing devices of the user can form an ecosystem of devices that can employ techniques described herein. These additional client devices and/or computing devices may be in communication with the computing device 410 (e.g., over one or more network(s)). As another example, a given computing device can be utilized by multiple users in a shared setting (e.g., in a household environment, in an enterprise or work environment, in a hospitality environment, etc.).

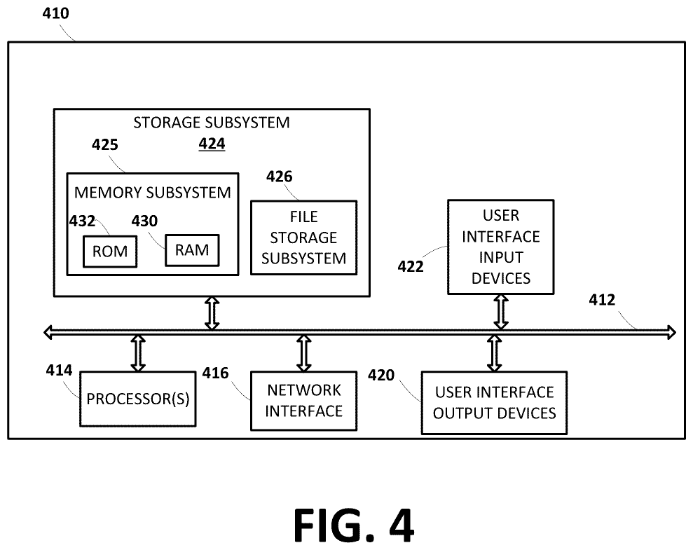

Turning now to FIG. 4, a block diagram of an example computing device 410 that may optionally be utilized to perform one or more aspects of techniques described herein is depicted. In some implementations, one or more of a client device, cloud-based component(s), and/or other component(s) may comprise one or more components of the example computing device 410.

Computing device 410 typically includes at least one processor 414 which communicates with a number of peripheral devices via bus subsystem 412. These peripheral devices may include a storage subsystem 424, including, for example, a memory subsystem 425 and a file storage subsystem 426, user interface output devices 420, user interface input devices 422, and a network interface subsystem 416. The input and output devices allow user interaction with computing device 410. Network interface subsystem 416 provides an interface to outside networks and is coupled to corresponding interface devices in other computing devices.

User interface input devices 422 may include a keyboard, pointing devices such as a mouse, trackball, touchpad, or graphics tablet, a scanner, a touchscreen incorporated into the display, audio input devices such as voice recognition systems, microphones, and/or other types of input devices. In general, use of the term “input device” is intended to include all possible types of devices and ways to input information into computing device 410 or onto a communication network.

User interface output devices 420 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computing device 410 to the user or to another machine or computing device.

Storage subsystem 424 stores programming and data constructs that provide the functionality of some or all of the modules described herein. For example, the storage subsystem 424 may include the logic to perform selected aspects of the methods disclosed herein.

These software modules are generally executed by processor 414 alone or in combination with other processors. Memory 425 used in the storage subsystem 424 can include a number of memories including a main random access memory (RAM) 430 for storage of instructions and data during program execution and a read only memory (ROM) 432 in which fixed instructions are stored. A file storage subsystem 426 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 426 in the storage subsystem 424, or in other machines accessible by the processor(s) 414.

Bus subsystem 412 provides a mechanism for letting the various components and subsystems of computing device 410 communicate with each other as intended. Although bus subsystem 412 is shown schematically as a single bus, alternative implementations of the bus subsystem may use multiple buses.

Computing device 410 can be of varying types including a workstation, server, computing cluster, blade server, server farm, or any other data processing system or computing device. Due to the ever-changing nature of computers and networks, the description of computing device 410 depicted in FIG. 4 is intended only as a specific example for purposes of illustrating some implementations. Many other configurations of computing device 410 are possible having more or fewer components than the computing device depicted in FIG. 4.

While several implementations have been described and illustrated herein, a variety of other means and/or structures for performing the function and/or obtaining the results and/or one or more of the advantages described herein may be utilized, and each of such variations and/or modifications is deemed to be within the scope of the implementations described herein. More generally, all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific implementations described herein. It is, therefore, to be understood that the foregoing implementations are presented by way of example only and that, within the scope of the appended claims and equivalents thereto, implementations may be practiced otherwise than as specifically described and claimed. Implementations of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

In some implementations, a method implemented by one or more processors is provided, the method includes receiving a user query that includes natural language, where the user query is generated based on user interface input provided at a client device. In some implementations, the method includes generating an initial prompt based on the user query, where the initial prompt includes at least the user query and an initial natural language request to generate initial content that is responsive to the user query. In some implementations, the method includes processing the initial prompt using a generative model to generate a first portion of a response to the user query. In some implementations, the method includes rendering the first portion of the response to the user. In some implementations, the method includes generating an additional prompt based on at least the user query. In some implementations, the method includes causing the additional prompt to be processed using the generative model or an additional generative model to generate a second portion of the response. In some implementations, the method includes causing the second portion of the response to be rendered to the user.

These and other implementations of the technology can include one or more of the following features.

In some implementations, the user query identifies one or more actions that include calling a given application programming interface (API). In some versions of those implementations, the initial natural language request of the initial prompt includes a request to rephrase the user query, and the second natural language request of the additional prompt includes a call to the given API. In some versions of those implementations, the initial natural language request of initial prompt includes an initial call to the given API, the second natural language request of the additional prompt includes an additional call to the given API, the initial call to the given API requests a first amount of data, the additional call to the given API requests a second amount of data, and the second amount of data is greater than the first amount of data. In some versions of those implementations, the initial natural language request of the initial prompt includes a set of historical information related to the given API, and the second natural language request of the additional prompt includes a call to the given API.

In some implementations, the user query identifies a set of content, where the user query identifies one or more actions corresponding to the set of content. In some versions of those implementations, the initial natural language request of the initial prompt includes a request to summarize an initial portion of the set of content, and the second natural language request of the additional prompt includes a request to summarize a remaining portion of the set of content. In some versions of those implementations, the initial portion of content is a first amount of data, the remaining portion of content is a second amount of data, and the first amount of data is smaller than the second amount of data.

In some implementations, the generative model includes a first quantity of parameters, where the additional generative model includes a second quantity of parameters, and where the first quantity of parameters is smaller than the second quantity of parameters.

In some implementations, the generative model is stored at the client device, and the additional generative model is stored at one or more remote computing devices.

In some implementations, the second natural language request of the additional prompt includes the first portion of the response.

In some implementations, causing the second portion of the response to be rendered includes generating a revision prompt that includes at least the first portion of the response, the second portion of the response, and a further natural language request to generate revised content that is responsive to the user query. In some versions of those implementations, the method further includes causing the revision prompt to be processed, using the generative model, the additional generative model, or a further generative model, to generate a revised second portion of the response.

In some implementations, the initial natural language request of the initial prompt includes an instruction of how to end the first portion of the response. In some versions of those implementations, the second natural language request of the additional prompt includes the instruction of how to end the first portion of the response. In some versions of those implementations, the second natural language request of the additional prompt includes a further instruction of how to begin the second portion of the response, where the further instruction of how to begin the second portion of the response is based on the instruction of how to end the first portion of the response.

In some implementations, a method implemented by one or more processors is provided, the method includes receiving a user query that includes natural language, where the user query is generated based on user interface input provided at a client device. In some implementations, the method includes determining, based on processing the user query, whether to generate a response to the user query which includes at least a first portion of the response and a second portion of the response. In some implementations, the method includes, in response to determining to generate the response to the user query which includes at least the first portion of the response and the second portion of the response: generating an initial prompt that includes at least the user query and an initial natural language request to generate initial content that is responsive to the user query. In some implementations, the method includes processing the initial prompt using a generative model to generate the first portion of the response. In some implementations, the method includes causing the first portion of the response to be rendered responsive to the user query. In some implementations, the method includes, prior to the causing the first portion of the response to be rendered: generating an additional prompt that includes at least the user query and a second natural language request to generate following content that is responsive to the user query. In some implementations, the method includes causing the additional prompt to be processed, using the generative model or an additional generative model, to generate the second portion of the response. In some implementations, the method includes causing the second portion of the response to be rendered responsive to the user query and temporally after rendering of the first portion of the response.

These and other implementations of the technology can include one or more of the following features.

In some implementations, determining whether to generate the response to the user query which includes at least the first portion of the response and the second portion of the response includes processing the user query to identify one or more actions that include calling a given application programming interface (API). In some versions of those implementations, the method further includes identifying a historical latency value of the given API. In some versions of those implementations, the method further includes determining whether the historical latency value satisfies one or more conditions. In some versions of those implementations, the method further includes, in response to determining that the historical latency value satisfies the one or more conditions, determining to generate the response to the user query which includes at least the first portion of the response and the second portion of the response.

In some implementations, determining whether to generate the response to the user query which includes at least the first portion of the response and the second portion of the response includes processing the user query to identify one or more actions that include the additional generative model. In some versions of those implementations, the method further includes identifying a generative model value, where the generative model value is based on the length of time to process one or more previous user queries using the generative model and/or the additional generative model. In some versions of those implementations, the method further includes determining whether the generative model value satisfies one or more conditions. In some versions of those implementations, the method further includes, in response to determining that the generative model value satisfies the one or more conditions, determining to generate the response to the user query which includes at least the first portion of the response and the second portion of the response.

In some implementations, determining whether to generate the response to the user query which includes at least the first portion of the response and the second portion of the response includes processing the user query to identify a set of content corresponding to the user query. In some versions of those implementations, the method further includes determining whether the set of content satisfies a threshold value. In some versions of those implementations, the method further includes, in response to determining that the set of content satisfies the threshold value, determining to generate the response to the user query which includes at least the first portion of the response and the second portion of the response.

In addition, some implementations include one or more processors (e.g., central processing unit(s) (CPU(s)), graphics processing unit(s) (GPU(s), and/or tensor processing unit(s))) coupled to one or more computer-readable storage devices (e.g., random access memory (RAM), flash memory, hard disk drive(s), a solid state drive(s), etc.). The computer-readable storage device(s) store instructions that, when executed by the processor(s), cause the processor(s) to perform various operations, including one or more operations described herein.

1. A method implemented by one or more processors, the method comprising:
receiving a user query that includes natural language, the user query being generated based on user interface input provided at a client device;
in response to receiving the user query:
generating an initial prompt that includes at least the user query and an initial natural language request to generate initial content that is responsive to the user query;
processing the initial prompt using a generative model to generate a first portion of a response;
causing the first portion of the response to be rendered responsive to the user query;
prior to the causing the first portion of the response to be rendered:
generating an additional prompt that includes at least the user query and a second natural language request to generate following content that is responsive to the user query;
causing the additional prompt to be processed, using the generative model or an additional generative model, to generate a second portion of the response; and
causing the second portion of the response to be rendered responsive to the user query and temporally after rendering of the first portion of the response.

2. The method of claim 1, wherein the user query identifies one or more actions that include calling a given application programming interface (API).

3. The method of claim 2, wherein the initial natural language request of the initial prompt includes a request to rephrase the user query, and wherein the second natural language request of the additional prompt includes a call to the given API.

4. The method of claim 2, wherein the initial natural language request of initial prompt includes an initial call to the given API, wherein the second natural language request of the additional prompt includes an additional call to the given API, wherein the initial call to the given API requests a first amount of data, wherein the additional call to the given API requests a second amount of data, and wherein the second amount of data is greater than the first amount of data.

5. The method of claim 2, wherein the initial natural language request of the initial prompt includes a set of historical information related to the given API, and wherein the second natural language request of the additional prompt includes a call to the given API.

6. The method of claim 1, wherein the user query identifies a set of content, and wherein the user query identifies one or more actions corresponding to the set of content.

7. The method of claim 6, wherein the initial natural language request of the initial prompt includes a request to summarize an initial portion of the set of content, and wherein the second natural language request of the additional prompt includes a request to summarize a remaining portion of the set of content.

8. The method of claim 6, wherein the initial portion of content is a first amount of data, wherein the remaining portion of content is a second amount of data, and wherein the first amount of data is smaller than the second amount of data.

9. The method of claim 1, wherein the generative model includes a first quantity of parameters, wherein the additional generative model includes a second quantity of parameters, and wherein the first quantity of parameters is smaller than the second quantity of parameters.

10. The method of claim 9, wherein the generative model is stored at the client device, and wherein the additional generative model is stored at one or more remote computing devices.

11. The method of claim 1, wherein the second natural language request of the additional prompt includes the first portion of the response.

12. The method of claim 1, wherein causing the second portion of the response to be rendered comprises:
generating a revision prompt that includes at least the first portion of the response, the second portion of the response, and a further natural language request to generate revised content that is responsive to the user query;
causing the revision prompt to be processed, using the generative model, the additional generative model, or a further generative model, to generate a revised second portion of the response; and
causing the revised second portion of the response to be rendered responsive to the user query and temporally after rendering of the first portion of the response.

13. The method of claim 1, wherein the initial natural language request of the initial prompt includes an instruction of how to end the first portion of the response.

14. The method of claim 13, wherein the second natural language request of the additional prompt includes the instruction of how to end the first portion of the response.

15. The method of claim 14, wherein the second natural language request of the additional prompt includes a further instruction of how to begin the second portion of the response, and wherein the further instruction of how to begin the second portion of the response is based on the instruction of how to end the first portion of the response.

16. The method of claim 1, wherein the initial natural language request of the initial prompt includes an indication of a data cache corresponding to the user query, and wherein processing the initial prompt using the generative model to generate the first portion of the response comprises selecting the first portion of the response from the data cache.

17. The method of claim 16, wherein the data cache corresponding to the user query includes a set of related user queries and corresponding generated responses.

18. The method of claim 16, wherein the data cache corresponding to the user query includes a set of pre-generated responses, where the pre-generated responses are generated based on processing the user query and/or a similar user query using the generative model.

19. A method implemented by one or more processors, the method comprising:
receiving a user query that includes natural language, the user query being generated based on user interface input provided at a client device;
determining, based on processing the user query, whether to generate a response to the user query which includes at least a first portion of the response and a second portion of the response;
in response to determining to generate the response to the user query which includes at least the first portion of the response and the second portion of the response:
generating an initial prompt that includes at least the user query and an initial natural language request to generate initial content that is responsive to the user query;
processing the initial prompt using a generative model to generate the first portion of the response;
causing the first portion of the response to be rendered responsive to the user query;
prior to the causing the first portion of the response to be rendered:
generating an additional prompt that includes at least the user query and a second natural language request to generate following content that is responsive to the user query;
causing the additional prompt to be processed, using the generative model or an additional generative model, to generate the second portion of the response; and
causing the second portion of the response to be rendered responsive to the user query and temporally after rendering of the first portion of the response.

20. The method of claim 19, wherein determining whether to generate the response to the user query which includes at least the first portion of the response and the second portion of the response comprises:
processing the user query to identify one or more actions that include calling a given application programming interface (API);
identifying a historical latency value of the given API;
determining whether the historical latency value satisfies one or more conditions; and
in response to determining that the historical latency value satisfies the one or more conditions, determining to generate the response to the user query which includes at least the first portion of the response and the second portion of the response.

21. The method of claim 19, wherein determining whether to generate the response to the user query which includes at least the first portion of the response and the second portion of the response comprises:
processing the user query to identify one or more actions that include the additional generative model;
identifying a generative model value, where the generative model value is based on the length of time to process one or more previous user queries using the generative model and/or the additional generative model;
determining whether the generative model value satisfies one or more conditions; and
in response to determining that the generative model value satisfies the one or more conditions, determining to generate the response to the user query which includes at least the first portion of the response and the second portion of the response.

22. The method of claim 19, wherein determining whether to generate the response to the user query which includes at least the first portion of the response and the second portion of the response comprises:
processing the user query to identify a set of content corresponding to the user query;
determining whether the set of content satisfies a threshold value; and
in response to determining that the set of content satisfies the threshold value, determining to generate the response to the user query which includes at least the first portion of the response and the second portion of the response.
